(19) United States
(12) Patent Application Publication
(10) Pub. No.: US 2023/0266609 A1
(43) Pub. Date: Aug. 24, 2023

(54) Eyeglass Shading Lens System For Selective Glare-Reduction

(71) Applicant: Richard O. Glasson, Morris Plains, NJ (US)

(72) Inventor: Richard O. Glasson, Morris Plains, NJ (US)

(21) Appl. No.: 18/158,644

(22) Filed: Jan. 24, 2023

Related U.S. Application Data
(60) Provisional application No. 63/311,819, filed on Feb. 18, 2022.

(51) Int. Cl. G02C 7/10; G02C 9/00

(52) U.S. Cl. CPC G02C 7/104; G02C 9/00

(57) ABSTRACT

A lens system for eyeglasses, for selectively shading areas of glare and bright lights in the wearer's field of view, while maintaining an unshaded field of view everywhere else. The system is adjustable and includes a means for attaching to a wearer's eyeglasses.

### FIELD OF THE INVENTION

This invention relates generally to the field of eyewear, and more particularly to the field of eyewear for shielding a user's eyesight against sources of extreme glare such as high-intensity vehicle headlights.

### BACKGROUND OF THE INVENTION

Blinding glare from oncoming vehicle headlamps is a common and increasing problem for drivers. This problem has increased in recent years due to the use of high-intensity headlamps. High-intensity automobile and truck headlamps, including high intensity discharge (HID) lamps (metal halide lamps, sodium vapor lamps, mercury vapor lamps and xenon arc lamps) and super-bright LED's, are now standard on most new vehicles. Additionally, most new vehicles operate with their headlights on as a default, regardless of time of day. The use of such headlamps results in blinding glare to the driver when drivers approach along opposite lanes. During nighttime driving this glare can be a significant distraction, and may destroy a driver's night vision temporarily, resulting in a dangerous situation. This problem can exist during daytime driving as well. Many high intensity headlamps can cause visual distraction and dazzling during full daylight.

Blinding glare or dazzle creates a dangerous driving condition for the affected driver. A driver who is blinded for even fractions of a second at high speeds can fail to react to a change in circumstances. For example, where a driver is blinded while negotiating a bend in the road, the inability to see the bend creates an instantaneous dangerous situation. Often, the blinding episode can last multiple seconds, and multiple oncoming vehicles can extend the blinding episode even longer. Drivers often divert their eyes even at high speeds creating highly dangerous situations.

While this problem has been long known, no satisfactory solution has emerged, and it remains ubiquitous today. Therefore, a solution is needed which provides easy to implement shielding and reduction of glare in the driver's eyes for approaching high-intensity lights.

### SUMMARY OF THE INVENTION

A shading lens system according to the principles of the invention is comprised of light-attenuating shaded lenses which attach to the user's eyeglasses. The lenses are specifically shaped and positioned to reduce glare transmission only in specific areas. Each lens provides a zone of glare reduction that approximately corresponds to the zone in the user's field of vision that is typically affected by blinding headlights from other vehicles. This is normally only a small portion of the user's total field of vision. The shading lenses do not occupy the remainder of the user's field of vision. The exemplary system includes a means for mounting the lenses, and attaching them to a user's eyeglasses. The user may adjust the location of the attachable lens system on their eyeglasses according to their preference. The shading lens system may be used as a tinted visor.

In an aspect of an exemplary system according to the invention, the shaded area covers a narrow band extending across the top of the lens near the brow. The wearer with slight downward tilting of the head temporarily locates the shielding zone of the lenses or visor to attenuate high intensity light sources. While tilting the head downward, the driver keeps the eyes fixed to see the road such that the field of view is maintained. Once the hazard dissipates, the user returns the head to a normal position such that the shading area of the system is out of or nearly out of the field of view. The shading lenses are not opaque; objects, vehicles, and people in the shaded area are still visible, but with reduced glare and dazzle. Thus, when no high intensity light sources are present, the user may position the head such that the lenses are not in the user's field of vision. In this way, the user is in total control of when to shade the field of view. In practice, the head tilting becomes habitual similar to a driver's use of mirrors.

The principles of the invention can be implemented in many exemplary embodiments. Examples include lenses attachable to existing eyewear, special purpose eyewear having a relatively narrow shaded area at the top, lenses having a narrowly shaded area that darkens in respect to the ambient light, lenses or visors that provide progressive shading, shaded appliques for temporarily affixing to lenses, or combinations of such examples. The width of the shaded band in an exemplary embodiment extends from just above the driver's field of view when the driver's head is in normal driving position to a width sufficient to shade the driver's field of view when the head is tilted downward at an angle of about 10 degrees to about 30 degrees.

Systems and articles according to the principles of the invention provide a practical and inexpensive means for reducing the glare of oncoming vehicle headlights without causing the driver to avert attention from the road. Another aspect of the invention provides a shading lens system that can be simply and easily affixed to different types of eyeglasses. A further aspect of the invention provides a system usable in any situation in which it is useful to attenuate a light source within the user's field of view, without affecting the field of view outside of or around the light source. An advantage of the present invention is simplicity and low cost so that it can be easily implemented and adapted for all drivers. One exemplary system clips onto the user's eyeglasses. It may be easily removed and re-installed according to the user's needs. Another advantage of the invention is ease of use and adaptability to individual preference. The system may be installed such that the shading area always occupies a portion of the user's field of view; or the system may be used in the manner of a visor, in which the user may bring the shading lens into or away from their field of view by slight tilting of the head.

### BRIEF DESCRIPTION OF THE DRAWINGS

The present invention is described with reference to the following figures, in which:

FIG. 1 shows an exemplary shading lens system in a front view;

FIG. 2 shows a rear perspective of a shading lens system;

FIG. 3 shows a shading lens system mounted on a pair of eyeglasses;

FIG. 4 shows a perspective view of the shading lens system mounted on a pair of eyeglasses;

FIG. 5 shows a view from the user's perspective, through eyeglasses, of an approaching vehicle;

FIG. 6 shows a view through eyeglasses in which the headlights of an approaching vehicle are shaded by an attached shading lens system; and

FIGS. 7a, 7b, 7c, 7d, 7e, 7f, and 7g show another exemplary glare blocking lenses according to the principles of the inventions.

FIG. 8 shows yet another exemplary glare blocking lenses according to the principles of the inventions.

FIGS. 9a, 9b, and 9c show another exemplary glare blocking lenses according to the principles of the inventions.

FIGS. 10a and 10b show yet another exemplary glare blocking lenses according to the principles of the inventions.

FIG. 11 shows another exemplary glare blocking lenses according to the principles of the inventions.

FIG. 12 shows yet another exemplary glare blocking lenses according to the principles of the inventions.

FIG. 13 shows another exemplary glare blocking lenses according to the principles of the inventions.

FIG. 14 shows yet another exemplary glare blocking lenses according to the principles of the inventions.

FIG. 15 shows another exemplary glare blocking lenses according to the principles of the inventions.

FIG. 16 shows yet another exemplary glare blocking lenses according to the principles of the inventions.

FIG. 17 shows another exemplary glare blocking lenses according to the principles of the inventions.

FIG. 18 shows yet another exemplary glare blocking lenses according to the principles of the inventions.

### DETAILED DESCRIPTION

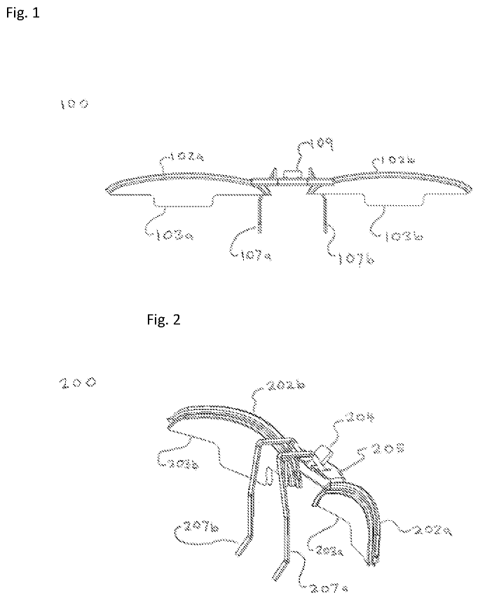

FIG. 1 shows a front view of an exemplary version of the shading lens system 100 in which a pair of lenses 103a and 103b are each affixed to a strut, pylon, or frame 1022a and 1022b. A central connecting beam 1055 connects the frames 1022a and 1022b. A pair of clip arms 107a and 107b are hinged together by a spring-tensioned hinge as would be understood in the art. The clip arms are operable by tab 109, which opens the clips arms against the spring tension of the hinge, and provides an attachment means for attaching the system to a pair of eyeglasses.

FIG. 2 shows another view of an example 200 of the shading lens system according to the principles of the invention in which the attaching elements are more clearly depicted. Clip arms 207a and 207b are formed of steel wire and covered with a protective plastic film. Central connecting beam 205 is formed of sheet metal and provided with openings for hinged elements comprising the clips arms 207a and 207b, as well as the operating tab 204. Strut, pylon, or frame 202a and 202b are attached to beam 205. Lenses 203a and 203b are affixed to frame 202a and 202b.

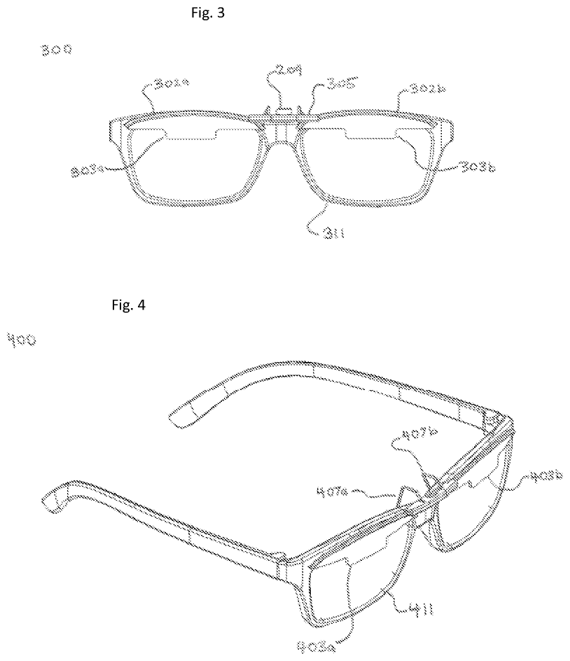

FIG. 3 shows another version 300 of a shading lens system mounted on a pair of eyeglasses 311. Lenses 303a and 303b occupy the top area of the eyeglass lens openings, corresponding to the top area of the eyeglass wearer's field of vision or to just above the top area of the wearer's field of vision. Frames 302a and 302b, connecting beam 305, and tab 309 are shown relative to the eyeglasses 311 in the mounted position.

FIG. 4 shows the shading lens system 400 mounted on a pair of eyeglasses 411. The perspective shows the clip arms 407a and 407b, reaching over the center of the eyeglasses 411. Lenses 403a and 403b are affixed to the upper front area of eyeglasses 11.

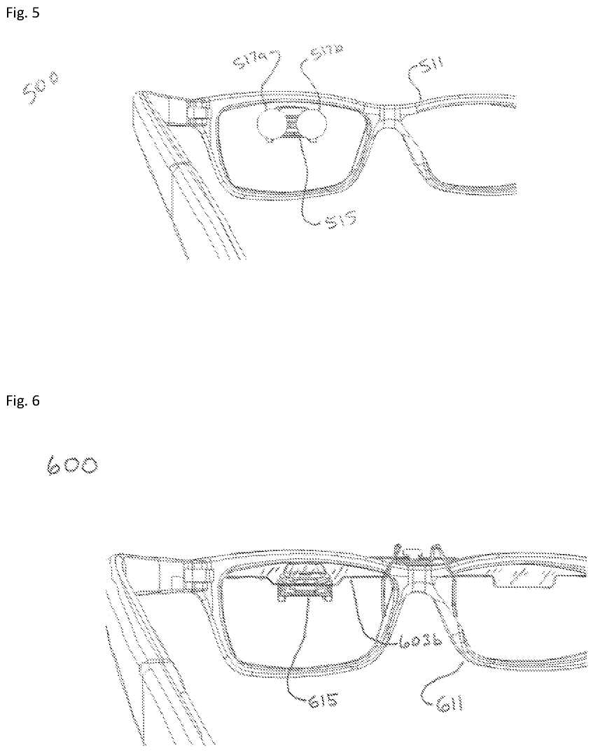

FIG. 5 shows a view 500 from the user's perspective, through unshaded eyeglasses 511, of a car 515, approaching with blinding glare 517a and 517b from hi-intensity headlights. FIG. 6 shows a view 600 from the user's perspective, through eyeglasses 611 utilizing the shaded lens system of the invention. A car 615 approaching with hi-intensity headlights is seen. The glare from the headlamps is shaded and reduced by the lens 603b of the system. The clear eyeglass lens 613 is shaded only in the area where blinding glare is present, leaving the user's field of view substantially unshaded.

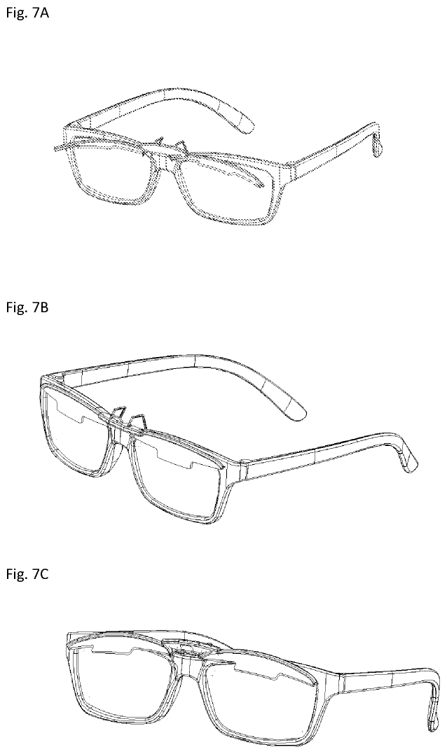

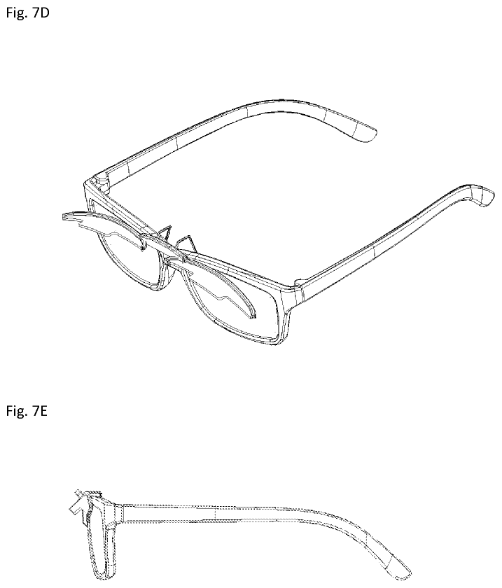

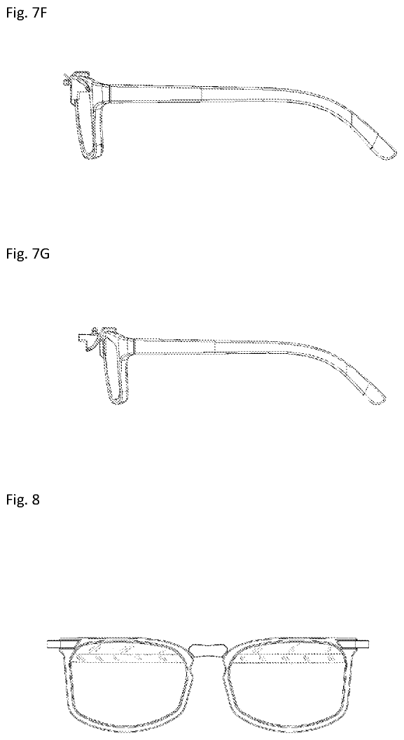

In another embodiment, shown in FIGS. 7A-7G, the attaching clip may be provided with a means for tilting the lenses. This provides the user the ability to finely adjust both the degree of tint (light-attenuating capability) as a tinted lens becomes darker when it is tilted from the normal plane of view. Another advantage of tilting the protective lens is fine adjustability with respect to the location of the lower extent and the distance from the lens edge to the user's eye.

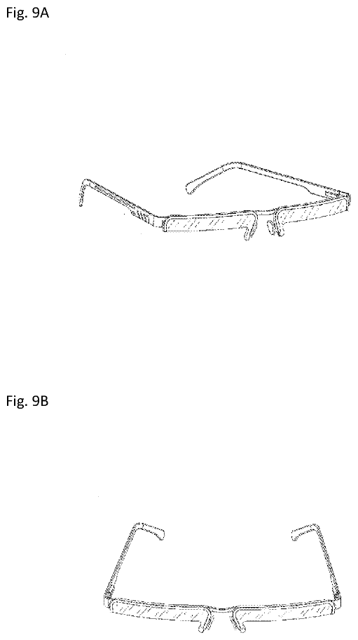

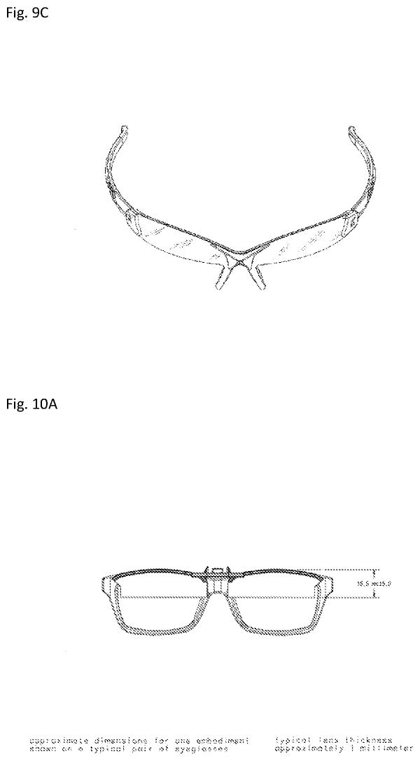

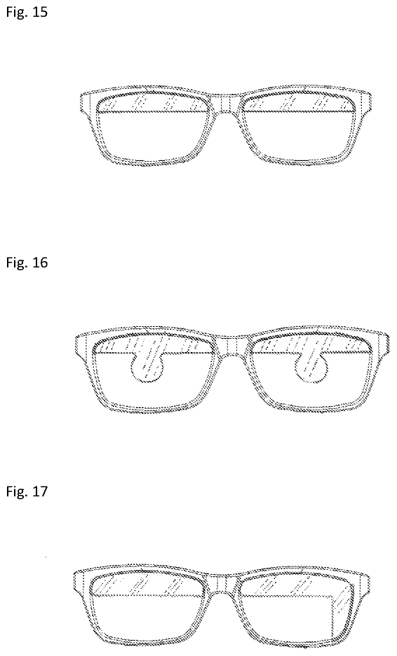

In other embodiments, for drivers that do not need or use glasses, the selective lenses may be incorporated into a pair of clear driving glasses, as in FIG. 15. As shown in FIG. 8, the shade protection may be applied to existing eyeglass lenses with an applique that can be cut and sized according to the user's individual characteristics. Alternatively, as shown in FIGS. 9A-C, the eyewear can include only the shaded lenses sized and positioned such that lenses are on the periphery or above the top field of view. Alternatively, the system can embody a shaded visor extending from just above the field of view, shaped and angled such that a slight tilt of the head forward allows the user to bring the shaded portion into the field of view.

The lenses according to the invention may be any light-attenuating type including tinted, polarized, opaque, progressively-tinted, corrective, magnifying, Fresnel, wavelength-blocking, clear lenses, or any combination of these lens types, or other known lens types. A person of ordinary skill in the art having read this disclosure will understand how to incorporate known light protecting lenses into a system according to the invention.

Skilled practitioners having read this disclosure will recognize that the means of attaching the shading lenses may include clips in other areas of the eyeglass frames, magnets, adhesives, appliques, applied coatings, and other means common to the art, without departing from the principles of the invention. A person having ordinary skill in the art having read this disclosure will know how to shade lenses such that the shading does not negatively impact the night driver's field of view without a tilt of the head. It is an advantage of a system according to the principles of the invention that the shading can be optimized for light intensity such that the shading would be unsuitable for ambient driving.

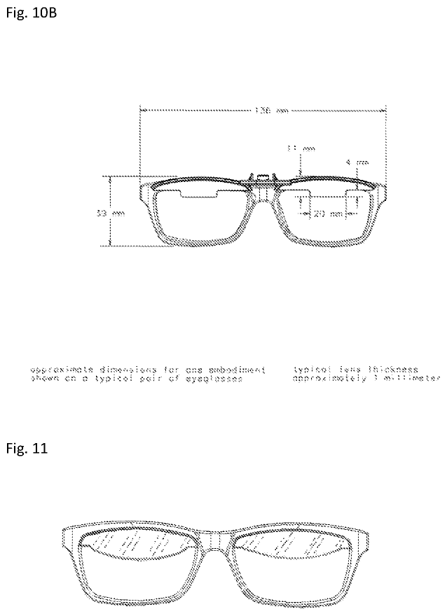

In an exemplary embodiment, the shaded area has a length dimension that extends horizontally across the eye lens and a width dimension that extends vertically. FIGS. 10A and 10B show exemplary dimensional drawings. The width dimension can range from approximately 10 mm to approximately 21 mm and is preferably selected to remain outside or nearly outside the field of view in normal driving conditions. All illustrated dimensions fall within the scope of described invention and further includes modifications to such dimensions as would be appreciated by the skilled artisan having read this disclosure.

A method of temporarily and selectively shading light from oncoming light sources such as headlamps includes wearing eyeglasses having lenses defining a light shading portion outside or nearly outside the top of the field of view. When the driver detects oncoming light that may upset the driver's viewing ability, the driver tilts his head forward from about 1 degree to about 30 degrees while keeping the eyes fixed on the same viewing position. This action brings the shaded portion of the lenses into the driver's field of view thereby shading the oncoming high intensity light. When the high intensity light source passes, the driver brings the head to normal position thereby orienting the shaded portion outside the normal field of view.

This invention is suitable for glare-blocking situations other than driving an automobile, such as operating boats, aircraft, precision work such as welding, surgery, hunting and other uses requiring selective shielding of the user's field of vision.

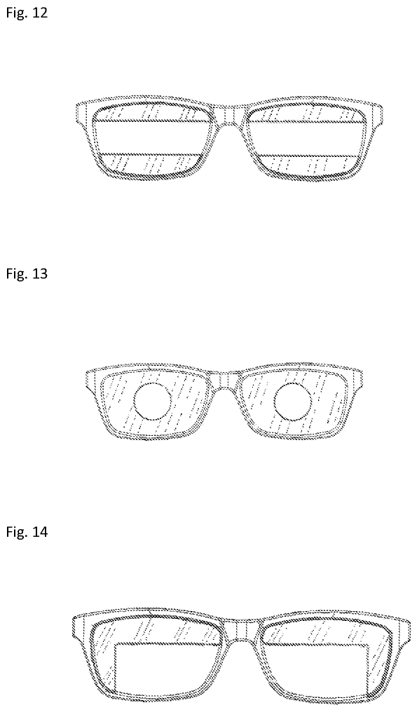

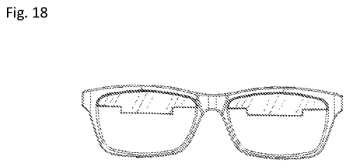

FIGS. 11-18 show other exemplary glare blocking lenses according to the principles of the inventions.

What is claimed is:

1. An article comprising:
an eyeglass frame; and
eyeglass lenses affixed in the frame, the eyeglass lenses having an upper shaded portion and a lower portion, the upper shaded portion having an upper edge positioned substantially lengthwise along an upper edge of the lenses and a lower edge extending horizontally across the lenses and terminating at a position above a pupil position of the lenses, wherein the upper shaded portion blocks light relative to the lower portion.

2. The article of claim 1 wherein the upper shaded portion blocks between 50 and 90 percent of incident light.

3. The article of claim 1 wherein the shaded portion upper edge and shaded portion lower edge define a width of less than 1.5 centimeters.

4. The article of claim 1 wherein the shaded portion upper edge and shaded portion lower edge define a width between 0.5 centimeters and 1.5 centimeters.

5. The article of claim 1 wherein the lower shaded portion comprises a substantially clear lens.

6. An article comprising an eyeglass frame holding eyeglass lenses, the lenses having a viewing window portion with a maximum length dimension of between 4.5 and 8 centimeters and a maximum width dimension between 0.5 and 2.5 centimeters, the viewing window portion defining an area above an uppermost edge of a wearer's pupil.

7. The article of claim 6 wherein the eyeglass lenses block more than 20% of incident light.

8. The article of claim 6 wherein the article is removably attachable to eyeglasses.

9. The article of claim 8 wherein the eyeglass lenses are rotatable with respect to the eyeglasses frame.

10. The article of claim 6 wherein the lenses the viewing window portion has a maximum length dimension of between 4.5 and 8 centimeters and a maximum width dimension between 0.5 and 1.3 centimeters.

11. The article of claim 6 wherein the lenses are positioned at an angle greater than 5 degrees relative to the vertical.

12. The article of claim 11 wherein the angle is between 5 degrees and 90 degrees relative to the vertical.

13. The article of claim 6 wherein the lenses are rotatable with respect to the eyeglasses frame from the substantially vertical to the substantially horizontal.

14. A method of operating a motor vehicle comprising the steps of:
wearing eyeglasses having lenses with a light blocking portion positioned substantially above a field of view;
selectively driving with a substantially vertical head orientation such that the light blocking portion remains substantially above the field of view;
detecting an oncoming light source;
selectively tilting the head forward while maintaining eye position to bring the light blocking portion substantially into the field of view; and
returning the substantially vertical head orientation.

15. The method of claim 14 wherein the eyeglasses comprise a frame holding the lenses and the lenses having a viewing window portion with a maximum length dimension of between 4.5 and 8 centimeters and a maximum width dimension between 0.5 and 2.5 centimeters, the viewing window portion defining an area above an uppermost edge of a wearer's pupil.
